(19) United States
(12) Patent Application Publication
(10) Pub. No.: US 2016/0096410 A1
(43) Pub. Date: Apr. 7, 2016

(54) SHOCK ABSORBER

(71) Applicant: Chung-Chuan LIN, TAICHUNG CITY (TW)

(72) Inventor: Chung-Chuan LIN, TAICHUNG CITY (TW)

(21) Appl. No.: 14/507,835

(22) Filed: Oct. 7, 2014

(51) Int. Cl. B60G 11/22; F16F 3/087; F16F 1/38

(52) U.S. Cl. CPC B60G 11/22; F16F 1/38; F16F 3/0873; F16F 2234/02; B60G 2202/14

(57) ABSTRACT

A shock absorber includes an outer pipe, an inner pipe and an elastic rubber cushion. The outer pipe is a hollow structure. The inner pipe is disposed in the outer pipe to define a receiving space between the inner and outer pipes, and is a hollow structure rotatable with respect to the outer pipe. The elastic rubber cushion is disposed in the receiving space and fixed to an inner wall of the outer pipe and an outer wall of the inner pipe, respectively. The shock absorber works in rotation manner to absorb shocks, which not only enables the shock absorber to absorb forces in al directions, but also reduces the size of the shock absorber. Besides, the shock absorber uses the elastic rubber cushion as a buffer, which produces no noise during the process of shock absorbing.

### BACKGROUND OF THE INVENTION

1. Field of the Invention

The present invention relates to a shock absorber, and more particularly to a torque type shock absorber.

2. Description of the Prior Art

A conventional shock absorber normally uses springs to absorb shocks. The spring is disposed between two objects, and will be compressed, stretched or decompressed when axial stress occurs between the two objects, so that shocks and impact forces can be absorbed.

However, the installation and shock absorbing effect of the spring shock absorber are restricted in the axial direction, and require a certain height in axial direction, which is not suitable for miniaturization, and this is the biggest problem hindering the application of springs to shock absorbers.

Besides, the spring will produce noise when absorbing shocks, and the noise won't stop until the spring stops moving. The noise might be small but still causes discomfort.

The present invention has arisen to mitigate and/or obviate the afore-described disadvantages.

### SUMMARY OF THE INVENTION

The primary objective of the present invention is to provide a shock absorber which works in a rotation manner to absorber shocks, so that the application of the shock absorber is restricted in axial direction, and the size of the shock absorber can also be reduced.

Another objective of the present invention is to provide a shock absorber which produces no noise during the process of shock absorbing.

To achieve the above objectives, a shock absorber in accordance with the present invention comprises an outer pipe, an inner pipe and an elastic rubber cushion. The outer pipe is a hollow structure. The inner pipe is disposed in the outer pipe to define a receiving space between the inner and outer pipes, and is a hollow structure rotatable with respect to the outer pipe. The elastic rubber cushion is disposed in the receiving space and fixed to an inner wall of the outer pipe and an outer wall of the inner pipe, respectively.

The advantages of the present invention are that the shock absorber of the present invention works in rotation manner to absorb shocks, which not only enables the shock absorber to absorb forces in al directions, but also reduces the size of the shock absorber. Besides, the shock absorber uses the elastic rubber cushion as a buffer, which produces no noise during the process of shock absorbing.

### BRIEF DESCRIPTION OF THE DRAWINGS

FIG. 1 is a perspective view of a shock absorber in accordance with a preferred embodiment of the present invention;

FIG. 2 is a front view of the shock absorber in accordance with the preferred embodiment of the present invention;

FIG. 3 is a cross sectional view of the shock absorber in accordance with the preferred embodiment of the present invention;

FIG. 4 is an exploded view of the shock absorber in accordance with the preferred embodiment of the present invention;

FIG. 5 is a front view of the shock absorber in accordance with a second preferred embodiment of the present invention;

FIG. 6 is a cross sectional view of the shock absorber in accordance with a third preferred embodiment of the present invention; and

FIG. 7 is a cross sectional view of the shock absorber in accordance with a fourth preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

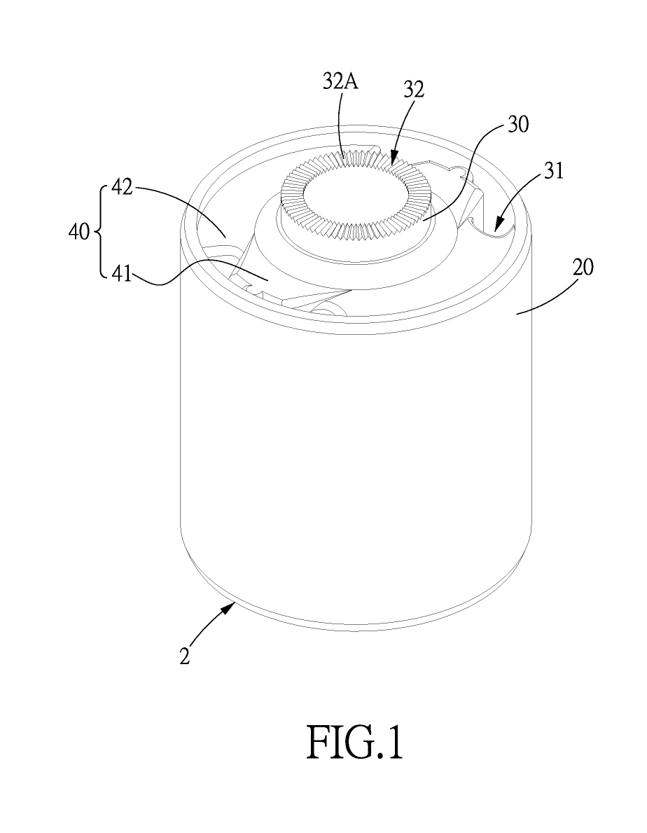

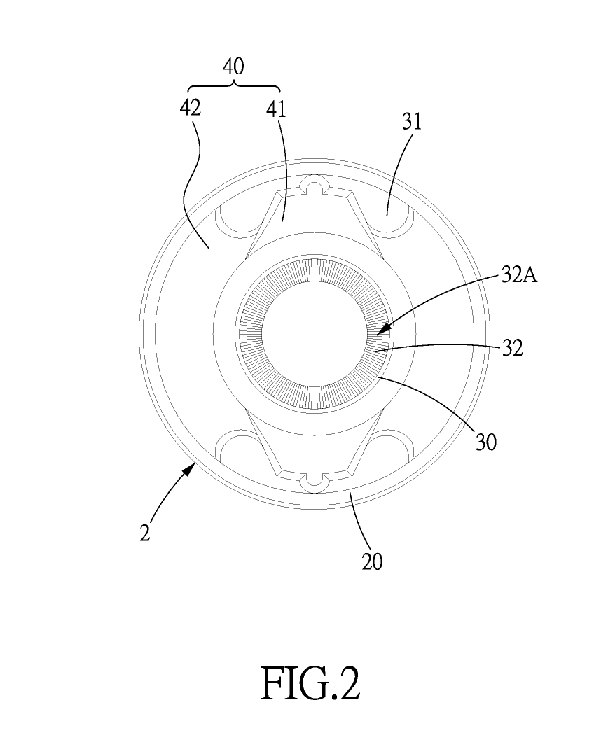

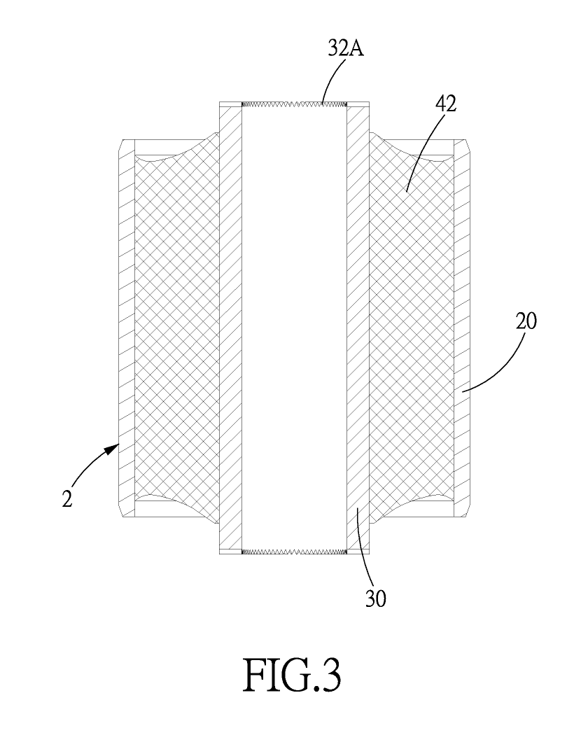

Referring to FIG. 1-3, a shock absorber in accordance with a preferred embodiment of the present invention comprises: an outer pipe 20, an inner pipe 30 and an elastic rubber cushion 40.

The outer pipe 20 is a hollow structure which is a hollow cylinder in this embodiment.

The inner pipe 30 is coaxially and rotatably disposed in the outer pipe 20, and a receiving space 31 is defined between the inner and outer pipes 30, 20. The inner pipe 30 is also a hollow cylinder and has an axial length longer than that of the outer pipe 20. At each of two ends of the inner pipe 30 is formed a connecting portion 32. In this embodiment, the connecting portion 32 is a toothed structure 32A annularly formed around the ends of the inner pipe 30.

The elastic rubber cushion 40 is disposed in the receiving space 31, and fixed to the inner wall of the outer pipe 20 and the outer wall of the inner pipe 30, respectively. In this embodiment, the elastic rubber cushion 40 includes a first elastic member 41 and a second elastic member 42. The first elastic member 41 is fixed to the inner wall of the outer pipe 20 and the outer wall of the inner pipe 30, and the second elastic member 42 is fixed to the inner wall of the outer pipe 20 and the outer wall of the inner pipe 30 and fixed to the first elastic member 41. The first and second elastic members 41, 42 can be made of different materials, so as to improve connection therebetween. In this embodiment, the elastic rubber cushion 40 does not fully occupies the receiving space 31, leaving some gaps between the elastic rubber cushion 40 and the receiving space 31, and the gaps are used as buffering spaces during shock absorbing process.

The elastic rubber cushion 40 is fixed to the inner wall of the outer pipe 20 and the outer wall of the inner pipe 30. When the inner pipe 30 rotates with respect to the outer pipe 20, the elastic rubber cushion 40 will produce a reverse force to pull the outer and inner pipes 20, 30, thus producing a shock absorbing effect. The source of shock absorbing effect comes from the deformation and recovery of the elastic rubber cushion 40, therefore, the shock absorber of the present invention produces no noise, as compared to the conventional spring shock absorber.

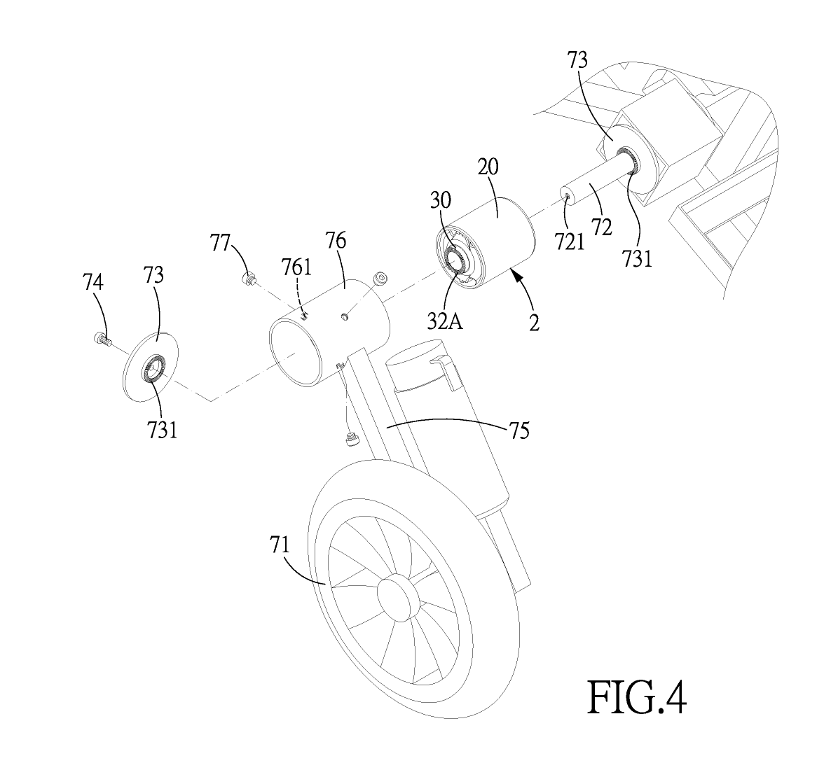

What mentioned are the main components of the preferred embodiment, for a better understanding of the effect and operation of the present invention, reference should be made to FIGS. 4 and 1-3 again, wherein the shock absorber 2 in accordance with the present invention is used on a wheel 71 of a scooter. The frame of the scooter includes a cylindrical horizontal rod 72 which is a provided with an inner thread 721. The inner pipe 30 of the shock absorber 2 is sleeved onto the horizontal rod 72, and the horizontal rod 72 is provided at both sides of the shock absorber 2 with a restricting member 73. One of the restricting members 73 located close to the frame is welded to the horizontal rod 72, and the other restricting member 73 which is located farther from the frame is fixed to the inner thread 721 of the horizontal rod 72 by a screw 74. A surface of each of the restricting members 73 is located toward the shock absorber 2 and formed with an annular toothed portion 731 for meshing with the toothed structure 32A of the inner pipe 30, so as to prevent the shock absorber 2 from rotating with respect to the horizontal rod 72.

The wheel 71 includes a connecting rod 75 which is provided at an end thereof with a sleeve 76 in the form of a hollow cylinder. On the surface of the sleeve 76 is formed a plurality of threaded holes 761. When the sleeve 76 is sleeved onto the outer pipe 20, a plurality of screws 77 is screwed through the threaded holes 761 to press against the outer surface of the outer pipe 20, so as to prevent the shock absorber 2 from rotating with respect to the sleeve 76. Besides, the connecting rod 75 extends upward and forward in an inclined manner with respect to the wheel 71.

When the scooter moves on a bumpy road, the connecting rod 75 of the wheel 71 will pivot clockwise or counterclockwise with respect to the horizontal rod 72. When the rotating torque is transmitted to the shock absorber 2, the elastic rubber cushion 40 between the outer and inner pipes 20, 30 will produce a reverse force to pull the outer and inner pipes 20, 30, thus producing a shock absorbing effect.

It is to be noted that except for the forces parallel to the directions of the horizontal rod 72 and the connecting rod 75, other forces which are applied to the wheel 71 in any directions can all be absorbed because of the component of torque, thus producing a shock absorbing effect. Hence, the shock absorber of the present invention is capable of absorbing forces in all directions, and the applicability of the present invention is much improved with respect to the spring shock absorber.

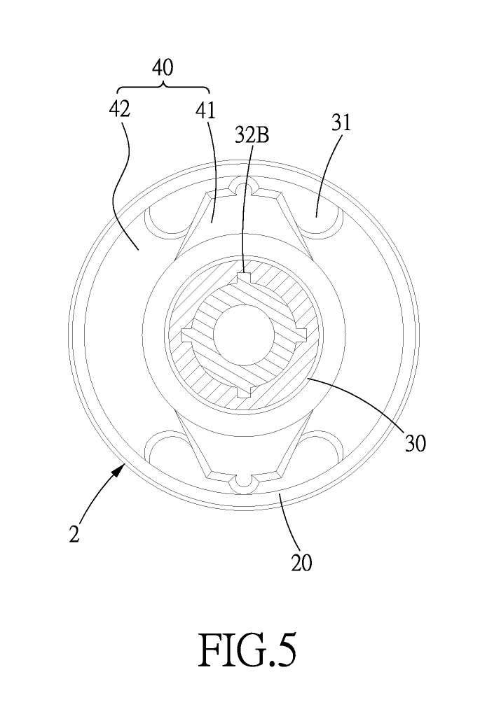

The inner and outer pipes of the present invention can be used on the wheel 71 of the scooter or other objects in many different ways. For example, as shown in FIG. 5, a plurality of engaging grooves 32B is axially formed in the inner surface of the inner pipe 30 and used as a connecting portion, and the four engaging grooves 32B as shown are arranged in a cross manner, and the horizontal rod 72 is provided with a plurality of ribs 78 for engaging with the engaging grooves 32B, which prevents the shock absorber 2 from rotating with respect to the horizontal rod 72 without having to form toothed structure at the ends of the inner pipe 30, so that manufacturing cost is reduced.

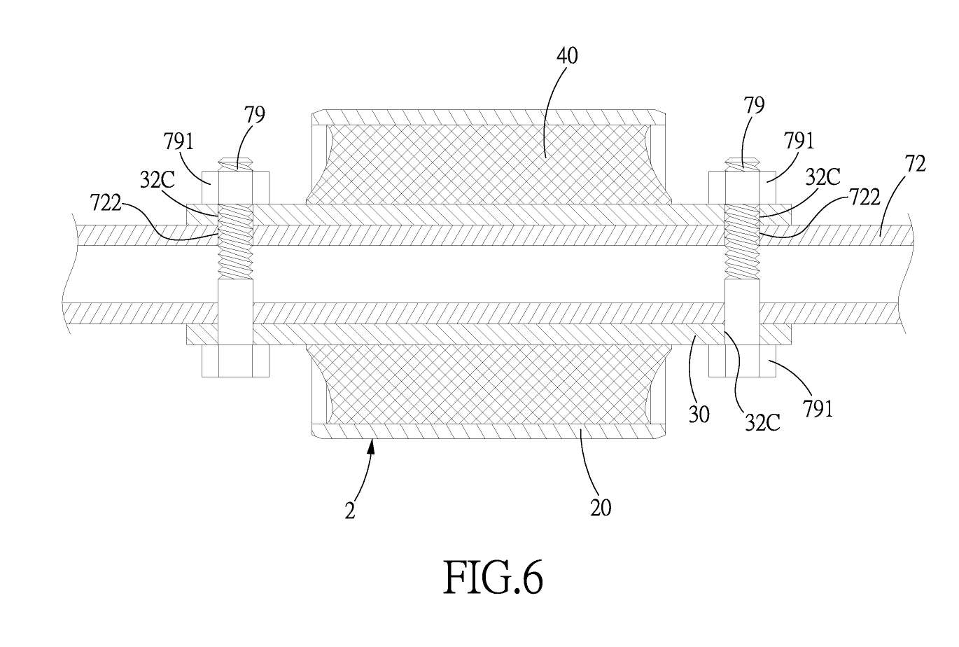

Referring then to FIG. 6, the inner pipe 30 is longer than the outer pipe 20, so that the two ends of the inner pipe 30 protrude out of the outer pipe 20, and the peripheral wall at each of the two ends of the inner pipe 30 are formed two aligned aperture 32C to serve as a connecting portion. The apertures 32C are formed in pairs. The horizontal rod 72 is also formed with an inserting hole 722 aligned with the apertures 32C. When the horizontal rod 72 is inserted in the inner pipe 30 of the shock absorber 2, two bolts 79 are inserted through the two apertures 32C at each end of the inner pipe 30 and the inserting hole 722, and then screwed with a nut 791, so that the inner pipe 30 is fixed to the horizontal rod 72, which also prevents the shock absorber 2 from rotating with respect to the horizontal rod 72.

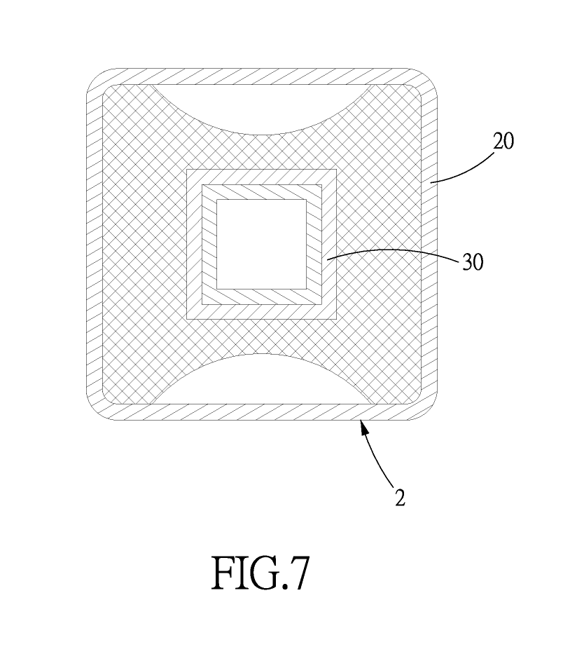

Referring finally to FIG. 7, the inner and outer pipes 30, 20 all are polygonal-shaped in cross section, for instance, a square cross section as shown. The horizontal rod and corresponding connecting member can also be rectangular shaped in cross section, which also prevents the shock absorber 2 from rotating with respect to the horizontal rod 72.

While we have shown and described various embodiments in accordance with the present invention, it is clear to those skilled in the art that further embodiments may be made without departing from the scope of the present invention.

1. A shock absorber comprising:
an outer pipe being a hollow structure;
an inner pipe disposed in the outer pipe to define a receiving space between the inner and outer pipes, the inner pipe being a hollow structure rotatable with respect to the outer pipe; and
an elastic rubber cushion being disposed in the receiving space and fixed to an inner wall of the outer pipe and an outer wall of the inner pipe, respectively;
wherein the elastic rubber cushion includes a first elastic member and a second elastic member which are made of different materials, whereby the elastic rubber cushion has different coefficients of elasticity.

2. The shock absorber as claimed in claim 1, wherein the inner and outer pipes are hollow cylinders.

3. The shock absorber as claimed in claim 1, wherein the inner pipe is coaxial with the outer pipe.

4. The shock absorber as claimed in claim 2, wherein the inner pipe is coaxial with the outer pipe.

5. The shock absorber as claimed in claim 2, wherein the inner pipe has an axial length longer than that of the outer pipe, and at each of two ends of the inner pipe is formed a connecting portion.

6. The shock absorber as claimed in claim 5, wherein the connecting portion is a toothed structure annularly formed around the ends of the inner pipe.

7. (canceled)

8. The shock absorber as claimed in claim 2, wherein a plurality of engaging grooves is axially formed in an inner surface of the inner pipe.

9. The shock absorber as claimed in claim 1, wherein the inner and outer pipes are polygonal-shaped in cross section.

10. The shock absorber as claimed in claim 1, wherein the first elastic member is fixed to the inner wall of the outer pipe and the outer wall of the inner pipe, and the second elastic member is fixed to the inner wall of the outer pipe and the outer wall of the inner pipe and fixed to the first elastic member.
